(19) United States
(12) Patent Application Publication
(10) Pub. No.: US 2019/0015964 A1
(43) Pub. Date: Jan. 17, 2019

(54) ANGLE ADJUSTABLE WRENCH

(71) Applicant: Shwu-Ruu Chern, Taichung (TW)

(72) Inventor: Shwu-Ruu Chern, Taichung (TW)

(21) Appl. No.: 15/650,897

(22) Filed: Jul. 15, 2017

(51) Int. Cl. B25G 1/06; B25B 23/16; B25B 13/46

(52) U.S. Cl. CPC B25G 1/063; B25B 23/00; B25B 13/46; B25B 23/16

(57) ABSTRACT

An angle adjustable wrench includes a handle, a main part, an adjustment unit and a jaw unit. The handle includes a head which has inner teeth defined in the inner periphery thereof. The head is installed in the main part. The adjustment unit includes a sleeve with an axial hole, two pawls, a resilient member and a button. The button includes a first neck and a second neck. The resilient member pushes the button, and the two pawls are pushed by the first neck and engaged with the inner teeth of the head. The jaw unit includes a movable jaw, a rotary wheel and a fixed jaw. The rotary wheel is threadedly mounted to the shaft. The main part together with the jaw unit are pivoted an angle relative to the handle by pushing the button.

### BACKGROUND OF THE INVENTION

### 1. Fields of the Invention

The present invention relates to a wrench, and more particularly, to an angle adjustable wrench whose jaws are angularly adjustable.

### 2. Descriptions of Related Art

The conventional wrench generally includes a handle and a wrench portion is connected to one end of the handle. The wrench portion is partially integrally formed with the handle, in other words, the object to be accessed by the wrench portion has to be located on the axial direction of the handle or the wrench portion cannot access the object. In some situations, the room is narrow which is not allowed the handle together with the wrench portion to be operated within the room. The conventional wrench becomes useless.

The present invention intends to provide an angle adjustable wrench whose jaws are angularly adjustable relative to the handle so as to eliminate the shortcomings mentioned above.

### SUMMARY OF THE INVENTION

The present invention relates to an angle adjustable wrench and comprises a handle having a head which is a ring-shaped head and formed on one end thereof. The head has inner teeth defined in the inner periphery thereof. A main part has a slot defined in one side thereof, and the slot is located between two plates. The head is inserted into the slot. The main part has a through hole defined through the two plates and the through hole communicates with the inner teeth of the head. The through hole has an inner anti-rotation portion defined in the inner periphery of each of the two plates. A passage is defined laterally through the main part. An aperture is defined in the main part and communicates with the passage. A positioning member extends through the main part.

An adjustment unit is connected to the main part and comprises a sleeve, two pawls, a resilient member and a button. The sleeve has an axial hole defined axially therethrough. The button has a first neck and a second neck. The sleeve has an outer anti-rotation portion defined in outside of upper portion and lower portion thereof. Two rooms are respectively defined in two opposite portions of the sleeve and the two pawls are respectively located in the two rooms. The sleeve is inserted in the through hole of the main part. The two inner anti-rotation portions are engaged with the two outer anti-rotation portions. The resilient member and the button are received in the axial hole of the sleeve. The resilient member biases the button so that the first neck pushes the two pawls to be engaged with the inner teeth in the head.

A jaw unit has a movable jaw, a rotary wheel and a fixed jaw. The movable jaw has a shaft extending therefrom which has outer teeth. The rotary wheel is threadedly connected to the outer teeth. The fixed jaw is integrally formed with the shaft. The movable jaw is located corresponding to the fixed jaw. The fixed jaw has a pivotal portion. The rotary wheel extends through the aperture of the main part. A positioning member extends through the main part and the pivotal portion which is inserted into the main part.

Preferably, a resilient unit is received in the main part and includes a resilient part having a resilient tongue, and a spring. The passage of the main part includes a recess and a side hole. The resilient part is inserted into the passage. The resilient tongue is located in the recess, and the spring is located in the side hole. The spring has one end thereof biasing the resilient part.

Preferably, the resilient part is a U-shaped part.

Preferably, the positioning member is a pin, and the pivotal portion includes a hole through which the pin extends.

Preferably, the outer anti-rotation portions of the sleeve each are outer polygonal sides, and the inner anti-rotation portions of the main part each are inner polygonal sides.

Preferably, the resilient member is a spring.

Preferably, the outer diameter of the first neck is larger than the outer diameter of the second neck.

Preferably, the movable jaw is perpendicularly connected to the shaft.

Preferably, a positioning ring is connected to the main part and surrounds the through hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the angle adjustable wrench of the present invention;

FIG. 2 is a perspective view to show the angle adjustable wrench of the present invention;

FIG. 3 is a cross sectional view of the angle adjustable wrench of the present invention;

FIG. 4 is a cross sectional view to show the adjustment unit in the wrench of the p resent invention;

FIG. 5 is another cross sectional view to show the adjustment unit in the wrench of the p resent invention;

FIG. 6 is a cross sectional view to show that the adjustment unit is pushed;

FIG. 7 is another cross sectional view of the disclosure in FIG. 6, and

FIG. 8 shows that the main part and the jaw unit are pivoted relative to the handle.

### DETAILED DESCRIPTION OF THE PREFERRED EMBODIMENT

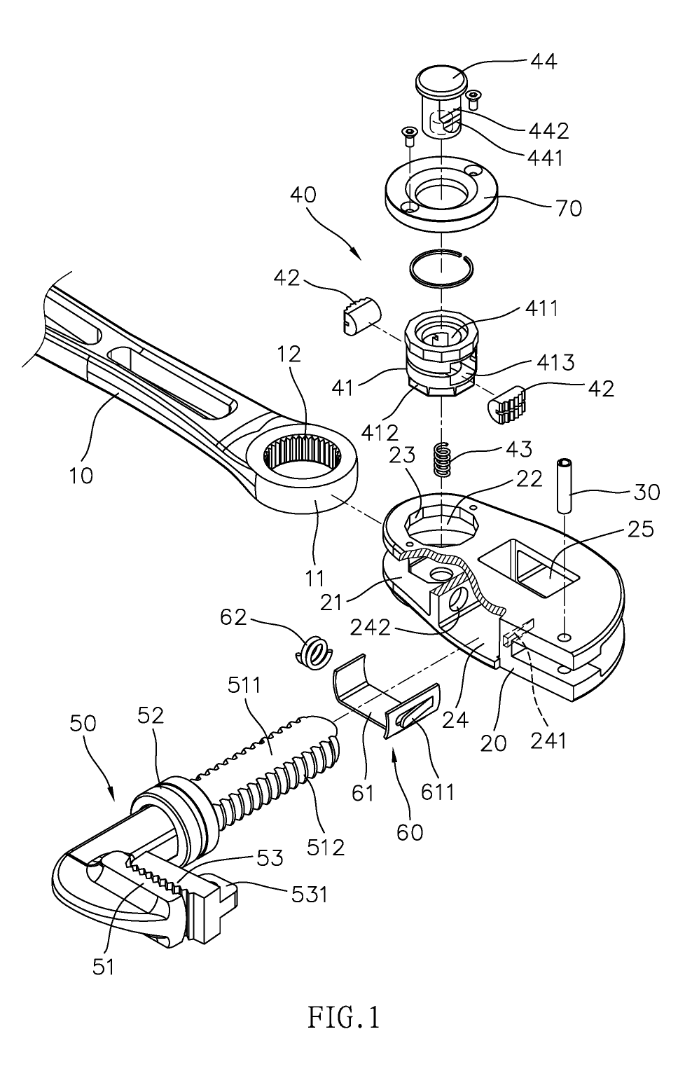

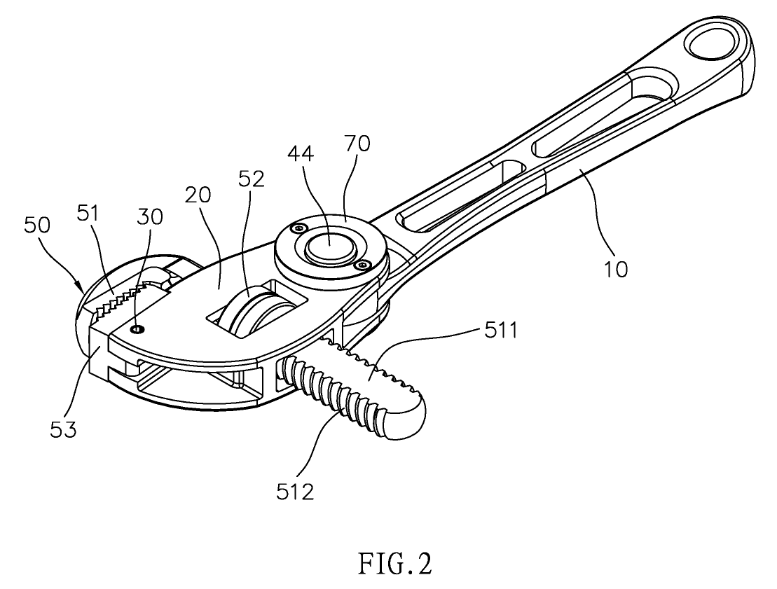

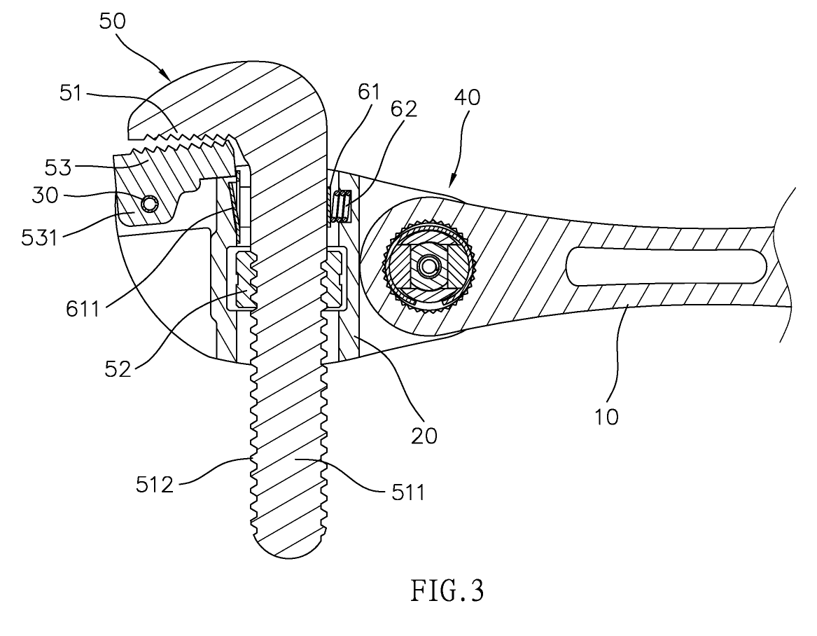

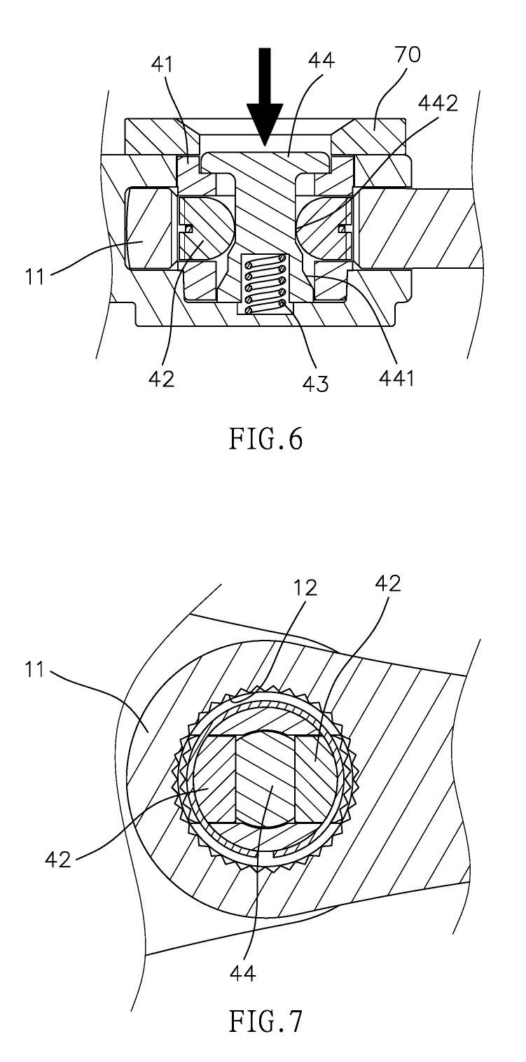

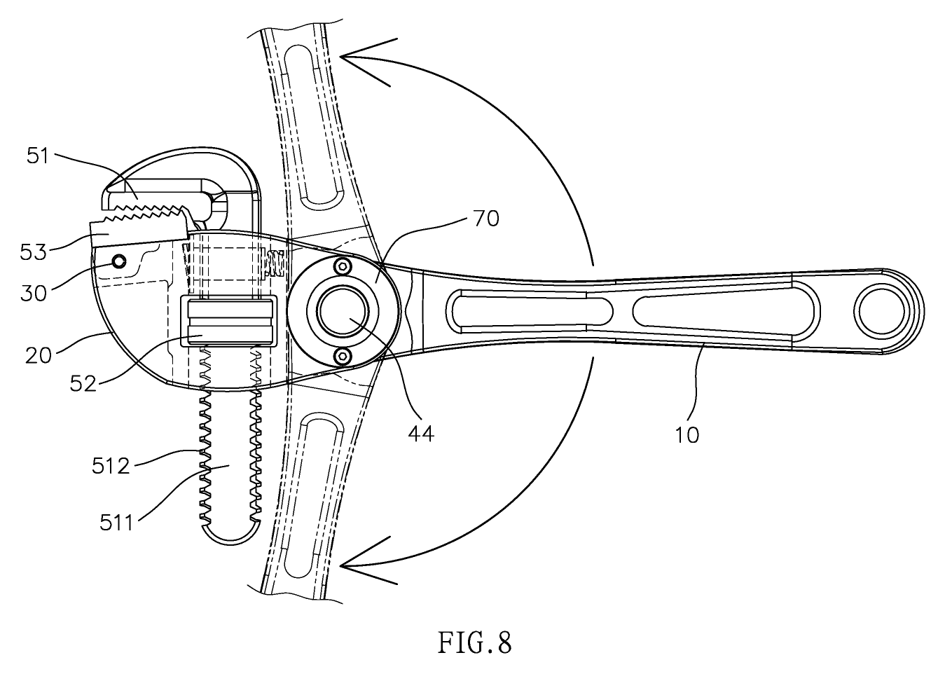

Referring to FIGS. 1 to 8, the angle adjustable wrench of the present invention comprises a handle 10 having a head 11 on one end thereof, and the head 11 is a ring-shaped head and has inner teeth 12 defined in the inner periphery thereof. A main part 20 has a slot 21 defined in one side thereof, and the slot 21 is located between two plates. The head 11 is inserted into the slot 21, and the main part 20 has a through hole 22 defined through the two plates. The through hole 22 communicates with the inner teeth 12 of the head 11. The through hole 22 has an inner anti-rotation portion 23 defined in the inner periphery of each of the two plates. A passage 24 is defined laterally through the main part 20. An aperture 25 is defined in the main part 20 and communicates with the passage 24. A positioning member 30 extends through the main part 20.

An adjustment unit 40 is connected to the main part 20 and comprises a sleeve 41, two pawls 42, a resilient member 43 and a button 44. The sleeve 41 has an axial hole 411 defined axially therethrough. The button 44 has a first neck 441 and a second neck 442, wherein the outer diameter of the first neck 441 is larger than the outer diameter of the second neck 442. The sleeve 41 has an outer anti-rotation portion 412 defined in outside of the upper portion and the lower portion thereof, so that when the sleeve 41 inserted in the through hole 22 of the main part 20, the two inner anti-rotation portions 23 are engaged with the two outer anti-rotation portions 412. In this embodiment, the outer anti-rotation portions 412 of the sleeve 41 each are outer polygonal sides, and the inner anti-rotation portions 23 of the main part 20 each are inner polygonal sides. Two rooms 413 are respectively defined in two opposite portions of the sleeve 41 and the two pawls 42 are respectively located in the two rooms 413. The resilient member 43 and the button 44 are received in the axial hole 411 of the sleeve 41. In this embodiment, the resilient member 43 is a spring. The resilient member 43 biases the button 44 so that the first neck 441 pushes the two pawls 42 to be engaged with the inner teeth 12 in the head 11.

A jaw unit 50 comprises a movable jaw 51, a rotary wheel 52 and a fixed jaw 53. The movable jaw 51 has a shaft 511 extending therefrom which has outer teeth 512. The movable jaw 51 is perpendicularly connected to the shaft 511. The rotary wheel 52 is threadedly connected to the outer teeth 512. The fixed jaw 53 is integrally formed with the shaft 511. The movable jaw 52 is located corresponding to the fixed jaw 53. The fixed jaw 53 has a pivotal portion 531 which has a hole. The rotary wheel 52 extends through the aperture 25 of the main part 20 so that the user may rotate the rotary wheel 52 to move the shaft 511 to adjust the distance between the fixed jaw 53 and the movable jaw 51. A positioning member 30, such as a pin, extends through the main part 20 and the hole of the pivotal portion 531 which is inserted into the main part 20 to connect the fixed jaw 51 to the main part 20.

A resilient unit 60 is received in the main part 20 and includes a resilient part 61 having a resilient tongue 611, and a spring 62. The passage 24 of the main part 20 includes a recess 241 and a side hole 242, wherein the resilient part 61 is inserted into the passage 24, and the resilient tongue 611 is located in the recess 241. The spring 62 is located in the side hole 242 and has one end thereof biasing the resilient part 61. In this embodiment, the resilient part 61 is a U-shaped part. A positioning ring 70 is connected to the main part 20 and surrounds the through hole 22.

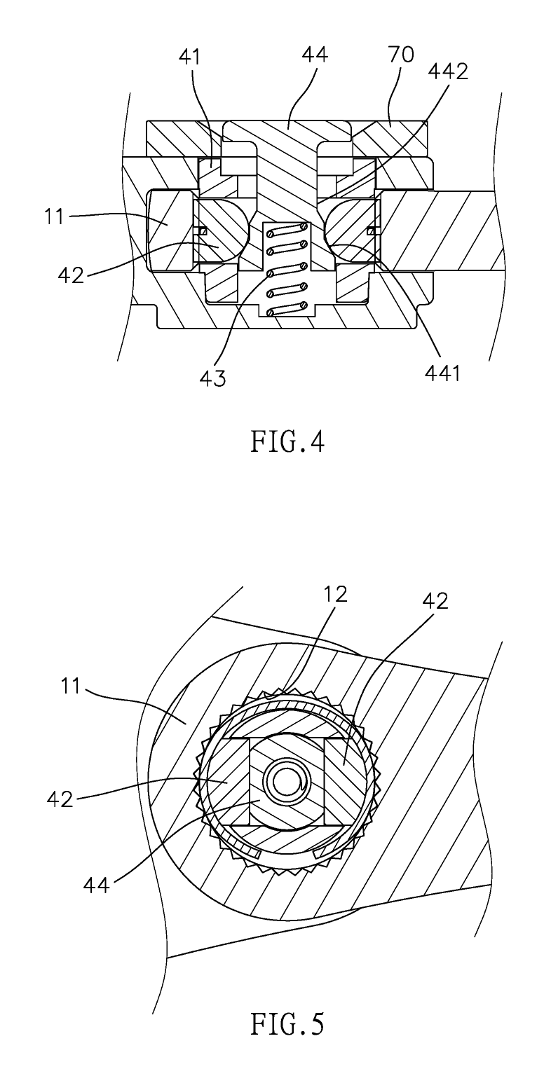

Referring to FIGS. 4 to 6, the

While we have shown and described the embodiment in accordance with the present invention, it should be clear to those skilled in the art that further embodiments may be made without departing from the scope of the present invention.

What is claimed is:

1. An angle adjustable wrench comprising:
a handle 10 having a head 11 which is a ring-shaped head and formed on one end thereof, the head 11 having inner teeth 12 defined in an inner periphery thereof;
a main part 20 having a slot 21 defined in one side thereof, the slot 21 located between two plates, the head 11 inserted into the slot 21, the main part 20 having a through hole 22 defined through the two plates and the through hole 22 communicating with the inner teeth 12 of the head 11, the through hole 22 having an inner anti-rotation portion 23 defined in an inner periphery of each of the two plates, a passage 24 defined laterally through the main part 20, an aperture 25 defined in the main part 20 and communicating with the passage 24;
a positioning member 30 extending through the main part 20;
an adjustment unit 40 connected to the main part 20 and comprising a sleeve 41, two pawls 42, a resilient member 43 and a button 44, the sleeve 41 having an axial hole 411 defined axially therethrough, the button 44 having a first neck 441 and a second neck 442, the sleeve 41 having an outer anti-rotation portion 412 defined in an outside of an upper portion and a lower portion thereof, two rooms 413 respectively defined in two opposite portions of the sleeve 41 and the two pawls 42 respectively located in the two rooms 413, the sleeve 41 inserted in the through hole 22 of the main part 20, the two inner anti-rotation portions 23 engaged with the two outer anti-rotation portions 412, the resilient member 43 and the button 44 received in the axial hole 411 of the sleeve 41, the resilient member 43 biasing the button 44 so that the first neck 441 pushes the two pawls 42 to be engaged with the inner teeth 12 in the head 11, and
a jaw unit 50 having a movable jaw 51, a rotary wheel 52 and a fixed jaw 53, the movable jaw 51 having a shaft 511 extending therefrom which has outer teeth 512, the rotary wheel 52 being threadedly connected to the outer teeth 512, the fixed jaw 53 integrally formed with the shaft 511, the movable jaw 52 located corresponding to the fixed jaw 53, the fixed jaw 53 having a pivotal portion 531, the rotary wheel 52 extending through the aperture 25 of the main part 20, a positioning member 30 extending through the main part 20 and the pivotal portion 531 which is inserted into the main part 20.

2. The angle adjustable wrench as claimed in claim 1, wherein a resilient unit 60 is received in the main part 20 and includes a resilient part 61 having a resilient tongue 611, and a spring 62, the passage 24 of the main part 20 includes a recess 241 and a side hole 242, the resilient part 61 is inserted into the passage 24, the resilient tongue 611 is located in the recess 241 and the spring 62 is located in the side hole 242, the spring 62 has one end thereof biasing the resilient part 61.

3. The angle adjustable wrench as claimed in claim 2, wherein the resilient part 61 is a U-shaped part.

4. The angle adjustable wrench as claimed in claim 1, wherein the positioning member 30 is a pin, the pivotal portion 531 includes a hole through which the pin extends.

5. The angle adjustable wrench as claimed in claim 1, wherein the outer anti-rotation portions 412 of the sleeve 41 each are outer polygonal sides, the inner anti-rotation portions 23 of the main part 20 each are inner polygonal sides.

6. The angle adjustable wrench as claimed in claim 1, wherein the resilient member 43 is a spring.

7. The angle adjustable wrench as claimed in claim 1, wherein an outer diameter of the first neck 441 is larger than an outer diameter of the second neck 442.

8. The angle adjustable wrench as claimed in claim 1, wherein the movable jaw 51 is perpendicularly connected to the shaft 511.

9. The angle adjustable wrench as claimed in claim 1 further comprising a positioning ring 70 which is connected to the main part 20 and surrounds the through hole 22.
